(19) United States
(12) Patent Application Publication
(10) Pub. No.: US 2016/0270587 A1
(43) Pub. Date: Sep. 22, 2016

(54) Dynamic Cold Brew Methods and Apparatus

(71) Applicants: Winnie Yu, Berkeley, CA (US); Alex Siow, Berkeley, CA (US)

(72) Inventors: Winnie Yu, Berkeley, CA (US); Alex Siow, Berkeley, CA (US)

(21) Appl. No.: 15/073,303

(22) Filed: Apr. 26, 2016

Related U.S. Application Data
(60) Provisional application No. 62/134,126, filed on Mar. 17, 2015.

(51) Int. Cl. A47J 31/44; A23F 5/26; A47J 43/046; A23F 3/18

(52) U.S. Cl. CPC A47J 31/44; A23F 3/18; A23F 5/26; A47J 43/046

(57) ABSTRACT

Methods and apparatus for dynamic cold brew of flavor materials such as tea and coffee in which the flavor materials are exposed for a short time to turbulent flow water.

### FIELD OF THE INVENTION

The methods and apparatus discussed and described herein are directed to cold brewing tea, coffee and other herbal materials commonly brewed for their flavor (hereafter sometimes referred to collectively as “flavor materials”) and, in particular, to such methods and apparatus that more quickly and thoroughly extract the flavors and nutrients from such flavor materials than known static cold brewing methods while obtaining the same advantages known to static cold brewing methods and providing others.

As water moves into flavor materials such as coffee particles or tea leaves, it dissolves or suspends hundreds of different substances and extracts them from the solids. If the water is hot, it extracts more rapidly and completely. Hot water also cooks as it extracts, forcing chemical reactions that transform some of the extracted substances into other things, and driving some aroma substances out of the liquid. Cold water, in contrast, extracts more slowly and selectively, produces a simpler extract, and doesn't change the original flavor substances, thereby preserving the more delicate flavors.

### BACKGROUND

Cold brewed, static, steeping is a known method of producing ice tea and ice coffee without dilution and the release of undesired elements. Such static cold brewing methods, however, take many hours (typically 12-20 hours or more) to make even a modest amount of tea or coffee and thus are rarely used outside the home and not without difficulty in commercial settings. As a result, static cold brewing, as known prior to the apparatus and methods described here, is not a practical method of brewing ice tea or ice coffee in quantity for consumption on demand.

### SUMMARY OF INVENTION

The present invention provides novel methods and apparatus for cold brewing of flavor materials including tea and ground coffee in a very short period of time and with more of the delicate tea and robust coffee flavors being extracted into the brewing water than with known static methods and apparatus, thereby producing a beverage in which the delicate flavors of the tea leaves and the robust flavors of coffee are captured and exposed.

According to the various embodiments described below, tea leaves (preferably whole, unbroken) or ground coffee beans or other flavor materials are disposed in a chamber with cold water. After allowing the materials to absorb water and expand for a short period of time, the water is caused to rapidly circulate in a turbulent pattern that keeps the tea leaves or coffee grounds separated from each other and dispersed throughout the water. This provides for the surfaces of essentially all of the tea leaves or coffee grounds to be exposed to the water by preventing the leaves or grounds to accumulate at the bottom of the chamber or cling together (which would prevent some leaf or grounds surfaces from being exposed). The turbulent pattern further creates relative movement between the circulating water and the expanded leaves and coffee grounds such that the water washes over the tea leaves or coffee grounds (as opposed to simply moving with the water) to rapidly extract and dissolve the soluble flavor and nutrient components into the water.

### DESCRIPTION OF DRAWINGS

FIG. 1 is a perspective view a blade assembly shown in a brewing chamber, which is shown in dashed lines;

FIG. 2 is a top plan view of a blade assembly in a brewing chamber;

FIG. 3 is a front elevational view of the blade assembly, with spacers between blades, in a brewing chamber with the chamber shown in dashed lines;

FIG. 4 is a cross-sectional view taken along line 4-4 in FIG. 2;

FIG. 5A is an enlarged end view of one blade;

FIG. 5B is an enlarged end view of one blade;

FIG. 6 is a front elevational view of the blade assembly with spacers removed;

FIG. 7A is a diagrammatic side elevational view of a brewing chamber of the present invention showing a drive motor attached to the blade assembly with product and fluid in the chamber;

FIG. 7B is a diagrammatic side elevational view of a brewing chamber of the present invention showing a drive motor spinning the attached blade assembly, showing the agitation of the product and fluid combination;

FIG. 8 is a schematic view showing the chamber inverted, transferring the combination of product and fluid to a filtering assembly yielding a brewed liquid;

FIG. 9 is a process flowchart indicating the process steps.

### DETAILED DESCRIPTION OF THE INVENTION

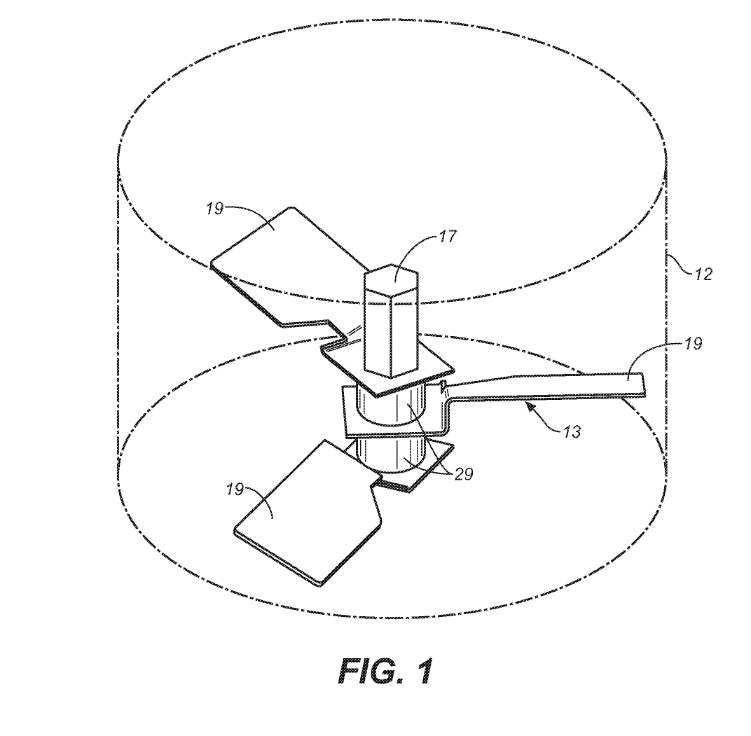

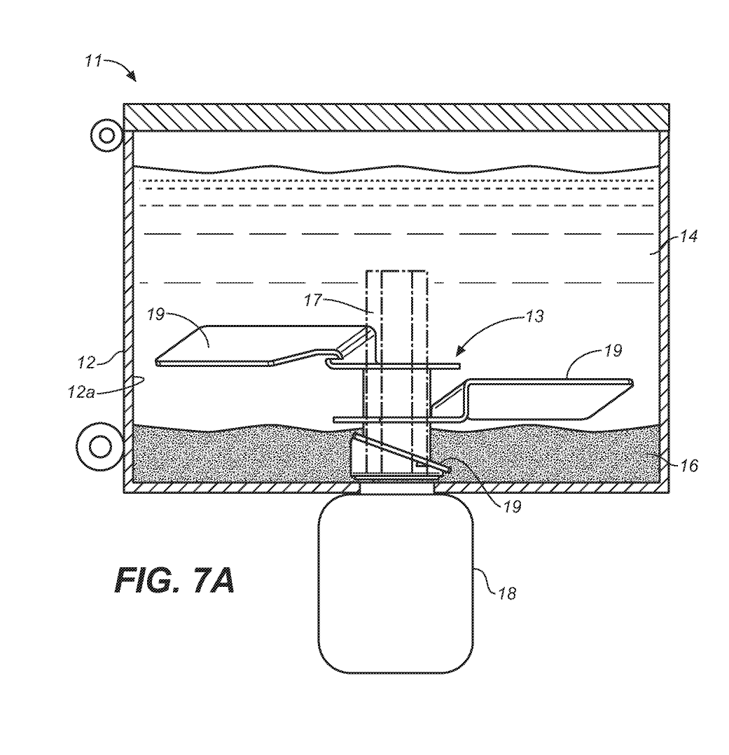

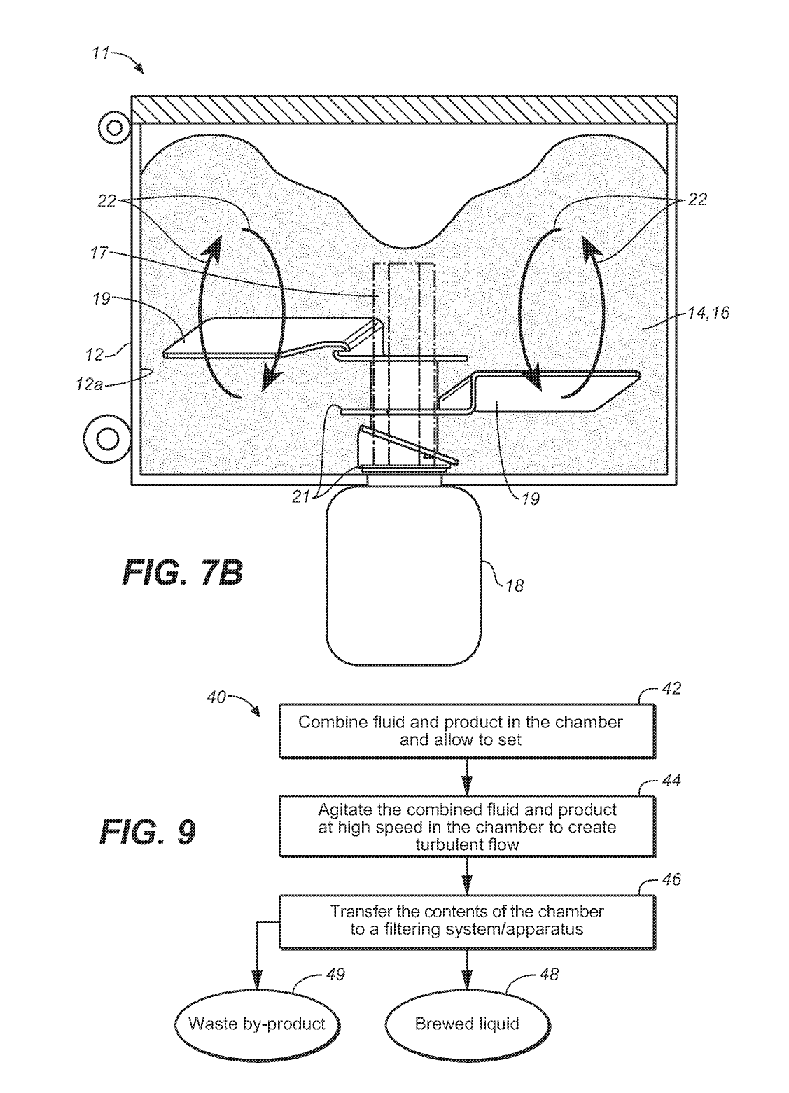

Referring to FIGS. 1, 2, 3 and 7A, a brewing apparatus 11 for cold brewing tea and coffee and other flavor materials includes a brewing chamber 12 outfitted with a propeller 13 for interacting with water 14 and flavor materials 16. In one embodiment, a shaft 17 that extends into the chamber 11 is connected to and driven by a motor 18 (FIG. 7A) to rotate at selected speeds. The propeller 13 is comprised of a plurality of blades 19 attached to the shaft 17 by brackets 21.

In operation, the motor 18 drives the propeller 13 to rotate at high speed to produce a turbulent flow in the water 14 that not only circulates water rotationally but also produces a thrust upward as illustrated representationally in FIG. 7B by arrows 22.

The upward thrust of the water's turbulent flow 22 prevents the flavor materials 16 from falling and settling to the bottom of the brewing chamber 12 and generally distributes them throughout the water 14 for as long as the blades 19 are rotated at a selected speed. In addition, the turbulent flow 22 that has the flavor material 16 flowing both circularly and longitudinally causes the water 14 and flavor materials 16 to circulate in opposition to each other which accelerates the transfer of the flavor and nutrient components from the flavor materials into the water 14.

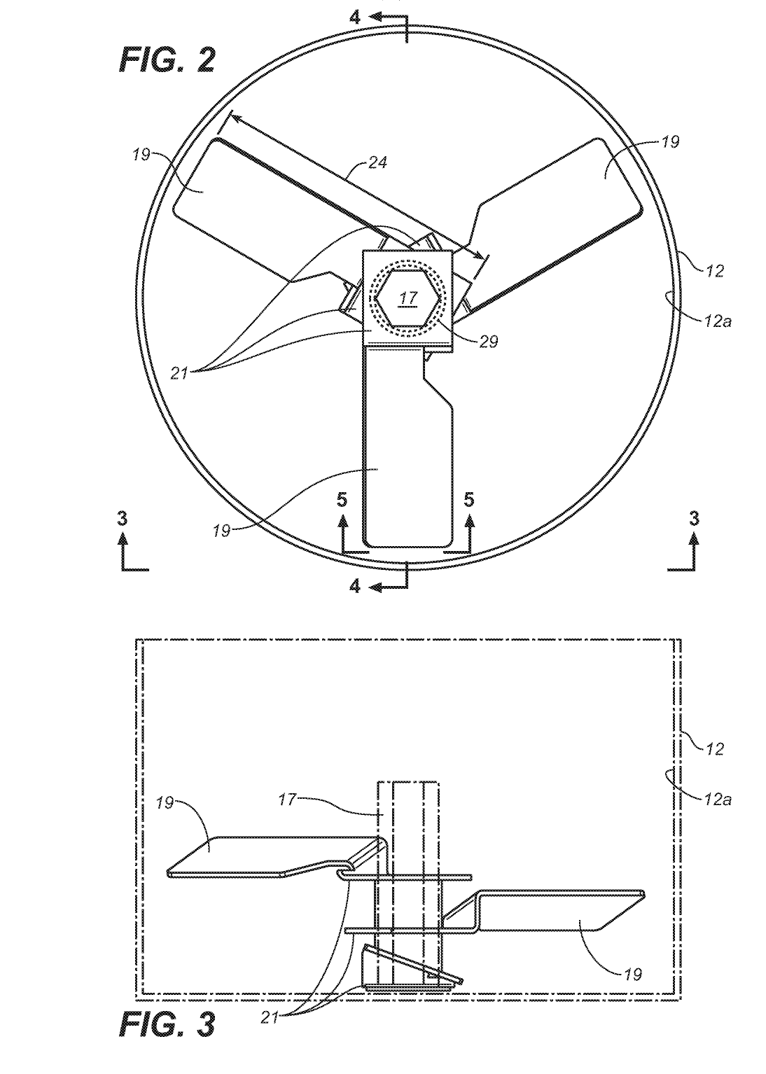

Referring to FIGS. 1-6, in one embodiment, the blades 19 are generally rectangular with a length 24 that reaches to between one-half and two inches of the inner wall 12a of brewing chamber 12 (FIG. 2). In addition to the turbulent flow 22 having an upward thrust that keeps the flavor materials dispersed and away from the blades 19, in one embodiment, the blades 19 have rounded, dull edges to prevent any damage to the flavor material 16 such as tea leaves or coffee bean parts (grounds) that do come in contact with the blades 19. The described apparatus and specific turbulent flow pattern prevents leaf or bean breakage. Such breakage would result from use of such appliances as a blender and causes over-extraction of bitter flavors and unwanted substances into the liquid. The specific turbulent flow of the present invention creates an emulsification of just oils and flavors with the water, whereas a blender would create a mix with pulp matter all blended together.

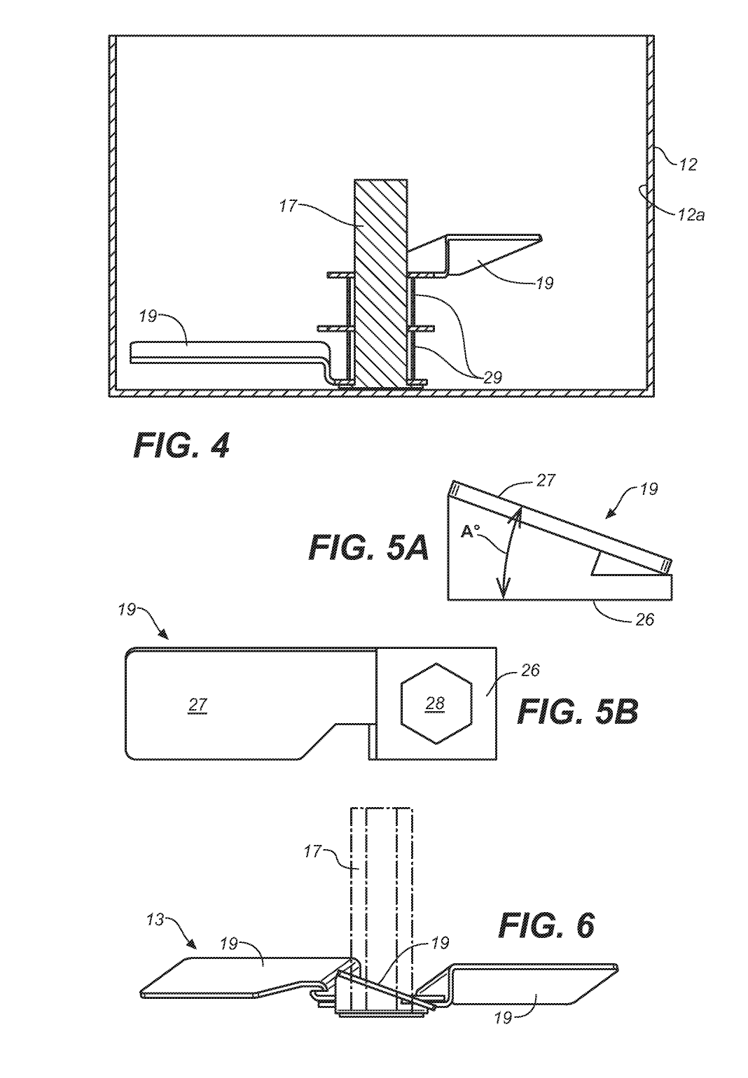

In one embodiment, the blades 19 comprise a shaft bracket 26 affixed to the paddle 27. An aperture 28 in bracket 26 is sized and shaped to fit closely around the shaft 17 and to be secured thereto. The shaft mount bracket 21 is generally disposed at a right angle to the shaft 17 when so disposed. In one embodiment, the shaft 17 has a hexagonal cross-section. In such embodiment, the aperture 28 in bracket 26 is also hexagonal so that blades 19 rotate with the shaft. As best seen in FIGS. 4, 5 and 6, the paddles 27 are affixed at an angle A to their respective brackets 26 (pitch) such that when blades 19 are mounted on the shaft 17, paddles 27 will have a pitch that produces the turbulent flow 22 that keeps the flavor materials 16 generally dispersed throughout the water 14 and prevents them from settling to the bottom of the chamber 12 or clumping together as described above.

As best seen in FIGS. 1 and 4, in one embodiment, the three blades 19 are separate from one another and mounted on the shaft 17 with spacers 29 between them placing them at vertically spaced locations from one another so as to rotate in different planes in chamber 12. In another embodiment, best seen in FIG. 6, the three blades 19 are mounted on shaft 13 with no spacers between them so as to rotate in generally the same plane. While a three-blade propeller 13 has been illustrated and has its advantages, alternative embodiments employing two or 4 three blades 19 can also produce the required turbulent flow. The choice of the number of blades 19, the pitch angle A, and the vertical spacing, vel non, between blades is primarily dependent on the size and shape of the brewing chamber 12.

A pitch angle A within the range 10 to 40 degrees will provide the desired flow pattern.

A factor in the process of the invention is the temperature of the water 14 during the brewing process. The process produces flavorful cold brew coffee and tea when the water temperature is kept between 32° F. and 60° F. (room temperature). The difference is time and flavor. For a process at 32° F., ice can be added to the water 14 to maintain the temperature throughout the process.

Another factor is the speed of the propeller 13. For minimizing the time to complete the process and extract a flavorful brew, the propeller 13 is rotated at between 1000 and 3000 rpm. Rotations as low as 700 rpm will produce a cold brew, but will take longer.

Yet another factor is the duration of the turbulent flow step. Times of between 4 and 15 minutes produce fully brewed coffee or tea with the subtle flavor changes occurring at different durations. In one embodiment, the duration is between 4 and 8 minutes.

Another factor is the ratio of flavor materials to water. For coffee, 1 to 8 pounds of coffee grounds per 6 gallons of water produces a cold brewed coffee beverage of varying strength; a preferred ratio is between 4 and 5 pounds of coffee grounds per 6 gallons of water.

For tea, 50 gm to 500 gm of tea leaves to 6 gallons of water produces a cold brewed tea beverage of varying strength; a preferred ratio is between 180 gm and 200 gm per 3 gallons of water and 300 to 360 gm of tea per 6 gallons of water.

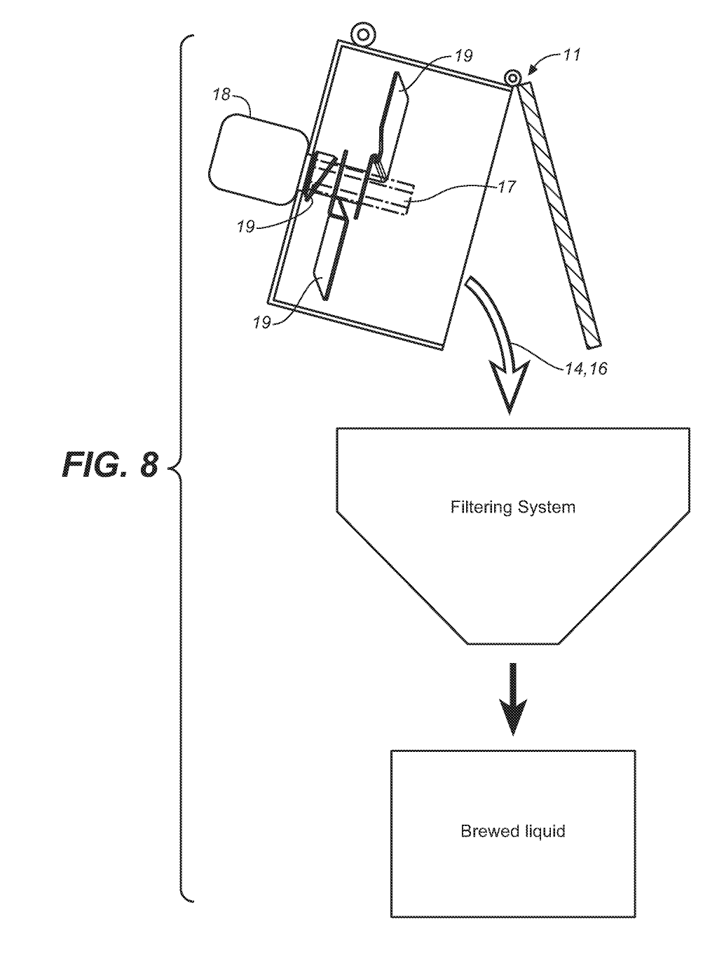

Referring to FIGS. 7A, 7B, 8 and 9, in one embodiment, the steps 40 of the method of cold brewing comprise: step 42, combining water 14 and flavor material 16 in a brewing chamber (such as chamber 12) and allowing the brewing material to sit (absorb the water) for a period of time (FIG. 7A); step 44, causing the water 14 into turbulent flow characterized by longitudinal as well as circular flow for a period of time whereby the flavor materials 16 are generally dispersed throughout the water and prevented from settling to the bottom of the chamber 12 (FIG. 7B); step 46, filtering the brewed liquid to separate out the solid particles of flavor materials (waste by-product) 49 from the brewed liquid 48 (FIG. 8).

Of course, various changes, modifications and alterations in the teachings of the present invention may be contemplated by those skilled in the art without departing from the intended spirit and scope thereof. As such, it is intended that the present invention only be limited by the terms of the appended claims.

What is claimed is:

1. A method of cold brewing flavor materials the steps comprising:
disposing a quantity of flavor materials in a brewing chamber;
adding water to the chamber;
causing the water in the chamber to move rapidly within the chamber.

2. The method of claim 1 wherein the water is at between 32° F. and 60° F.

3. The method of claim 2 where the water is caused into turbulent flow characterized by both a circular flow and a longitudinal flow that has an upward thrusting component.

4. The method of claim 3 wherein said turbulent flow is produced by a propeller that rotates at between 700 and 3000 rpm.

5. The method of claim 4 where the step causing the water into turbulent flow is maintained for between 3 and 15 minutes.

6. The method of claim 1 where the flavor material is ground coffee.

7. The method of claim 6 where the ratio of coffee to water is 1 to 8 pounds of ground coffee to 6 gallons of water.

8. The method of claim 6 where the ratio of coffee to water is between 4 and 6 pounds of ground coffee per 6 gallons of water.

9. The method of claim 6 where the flavor material is tea.

10. The method of claim 9 where the ratio of tea to water is 50 gm to 500 gm of tea leaves to 6 gallons of water.

11. The method of claim 9 where the ratio of tea to water is between 180 gm and 200 gm of tea per 3 gallons of water.

12. The method of claim 9 where the ratio of tea to water is between 300 to 360 gm of tea per 6 gallons of water.

13. The method of claim 6 where the step causing the water into turbulent flow is maintained for between 3 and 10 minutes.

14. The method of claim 9 where the step causing the water into turbulent flow is maintained for between 3 and 10 minutes.

15. The method of claim 6 where the water temperature is between 32° F. and 40° F.

16. The method of claim 9 where the water temperature is between 32° F. and 40° F.
